(19) United States
(12) Patent Application Publication
(10) Pub. No.: US 2026/0308838 A1
(43) Pub. Date: Oct. 8, 2026

(54) INDUSTRIAL FABRIC WITH LASER INDUCED STRUCTURES

(71) Applicant: AstenJohnson International, Inc., Charleston, SC (US)

(72) Inventor: Allan MANNINEN, Stittsville (CA)

(73) Assignee: AstenJohnson International, Inc., Charleston, SC (US)

(21) Appl. No.: 19/484,950

(22) PCT Filed: May 23, 2024
(86) PCT No.: PCT/US2024/030757

§ 371 Date: Nov. 17, 2025

Related U.S. Application Data
(60) Provisional application No. 63/468,296, filed on May 23, 2023.

(51) Int. Cl. D06M 10/00; D03D 15/283; D03D 15/292; D04H 1/4382; D21F 7/08

(52) U.S. Cl. CPC D06M 10/005; D03D 15/283; D03D 15/292; D04H 1/43828; D21F 7/08

(57) ABSTRACT

An industrial fabric formed of a base material that is continuous or has ends that are joined in order to form a belt having a first surface, and may include a system of MD yarns connected to a system of CD yarns, a film, or a non-woven. At least a portion of the base material at the first surface includes a first inner material formed of a first polymer mixed with a laser absorbing material, a first outer material formed of a second polymer, and a first blowing agent located in at least one of the first inner material or the first outer material. Protrusions extend from the first surface at selected locations, the protrusions include an expanded part of the first outer material with a foamed or cellular structure created by the first blowing agent being activated in a region in or adjacent to the first inner material.

### CROSS-REFERENCE TO RELATED APPLICATIONS

This application is a 371 National Phase of PCT/US2024/030757, filed May 23, 2024, which claims priority from U.S. Provisional Patent Application No. 63/468,296, filed May 23, 2023, both of which are incorporated herein by reference as if fully set forth.

### FIELD OF THE INVENTION

The invention concerns industrial fabrics, and more specifically papermaking fabrics for use in a papermaking process. It is particularly concerned with through-air dryer (TAD) fabrics where raised structures and/or patterns formed by such raised structures are provided on the paper support surface.

### BACKGROUND OF THE INVENTION

Papermaking fabrics, and in particular TAD fabrics, are known which are used in TAD processes for non-compressive water-removal operations on the TAD machine. Dewatering of a nascent web of fibers used to form the paper product is accomplished by a vacuum on the forming fabric in a known manner, and then by through drying on the TAD fabric in a through-air dryer. The use of non-compressive water-removal technologies results in a product with improved properties, which is particularly useful for tissue and paper towel products. Among these properties are improved bulk, CD stretch, and absorbency. In North America an increasing percentage of tissue production is now done on TAD machines.

In order to enhance the bulk and absorbency of the paper product, it is known to provide a paper support surface profile of the TAD fabric that includes protrusions and/or pockets that are transferred to the paper product. These protrusions and/or pockets can be formed by the weave pattern of the CD (cross direction) and MD (machine direction) yarns in the fabric, or by a material laminated onto the surface of a base fabric.

While satisfactory in many respects, there is still a need to improve both the production of TAD fabrics as well as the various different surface patterns on the paper support side that are formed by protrusions and/or pockets.

There are also needs in other areas of papermaking where improvements would be desirable in order to provide water marks and/or increase bulk and/or absorbency more efficiently and/or at a lower cost.

The present invention is directed to addressing these as well as other needs.

### SUMMARY

Briefly stated, an industrial fabric is provided which includes a base material that is formed continuously or has ends that are joined in order to form a belt having a first surface and a second surface. At least a portion of the base material at the first surface includes a first inner material formed of a first polymer mixed with a laser absorbing material, such as carbon black or other laser absorbing dye, and a first outer material formed of a second polymer. A first blowing agent is located in at least one of the first inner material or the first outer material. Protrusions extend from the first surface at selected locations, with the protrusions comprising an expanded part of the first outer material with a foamed or cellular structure created by the first blowing agent in the first inner material and/or the first outer material being activated in a region in or adjacent to the first inner material. These protrusions form a topographical pattern of protrusions on the first surface in a simple and easily programmable manner to provide different topographic patterns.

In one embodiment, the protrusions are encapsulated between a solid portion of the first outer material that does not include the foamed or cellular structure and the first inner material. This can be part of the first outer material where the blowing agent has not been activated when the blowing agent is in the first outer material. It can also be encapsulated by the first outer material alone when the blowing agent is located in the first inner material.

In another embodiment, at least a portion of the base material at the second surface includes a second inner material formed of a third polymer mixed with a laser absorbing material and a second outer material formed of a fourth polymer, and a second blowing agent is located in at least one of the second inner material or the second outer material. Second protrusions extend from the second surface at selected second surface locations, with the second protrusions comprising an expanded part of the second outer material with a foamed or cellular structure created by the second blowing agent being activated in a region in or adjacent to the second inner material.

In one embodiment, the second protrusions are encapsulated between a solid portion of the second outer material that does not include the foamed or cellular structure and the first inner material. This can be part of the second outer material where the second blowing agent has not been activated when the second blowing agent is in the second outer material. It can also be encapsulated by the second outer material alone when the second blowing agent is located in the second inner material. This allows protrusions to be formed on both support surfaces. Here, the first and the third polymers may be a same polymer, and the second and the fourth polymers may also be a same polymer, and the first and the second blowing agents may be a same blowing agent.

It is also possible for the base material to have second protrusions that extend from the second surface at selected locations, with the second protrusions comprising an expanded part of the first outer material with a foamed or cellular structure created by the first blowing agent being activated in a region in or adjacent to the first inner material at the second surface.

The second protrusions form a topographical pattern of protrusions on the second surface in a simple and easily programmable manner to provide different topographic patterns.

In one embodiment, the first blowing agent is a chemical blowing agent. Here, the chemical blowing agent can be heat activated. In one preferred arrangement, the chemical blowing agent is heat activated at an activation temperature in a range from 160-350 °C the blowing agent could also be a physical blowing agent.

In one embodiment, the base material is a fabric including a system of MD yarns connected to, for example interwoven with, a system of CD yarns and is formed continuously or has ends that are joined in order to form the belt, and at least one of the CD yarns or the MD yarns include a core formed of the first polymer mixed with the laser absorbing material to form the first inner material, and a sheath or layer formed of the second polymer and the first blowing agent to form the first outer material.

In one embodiment, only the at least some of the CD yarns include the core formed of the first polymer mixed with the laser absorbing material and the sheath or layer formed of the second polymer and the first blowing agent. Here the MD yarns do not include any blowing agent and are not activatable to form protrusions. It is possible for some or all of the CD yarns to include the core formed of the first polymer mixed with the laser absorbing material and the sheath or layer formed of the second polymer and the first blowing agent.

In one specific embodiment, the sheath or layer comprises an inner portion formed of the second polymer and the first blowing agent and an outer portion formed of a polymer without any blowing agent. This ensures a non-permeable layer of a polymer over the foamed or cellular structure created by the first blowing agent.

In one embodiment, the second polymer is a thermoplastic elastomer (TPE) synthesized from homopolymer, copolymers or blending, and includes for example thermoplastic urethane (TPU), thermoplastic olefins, thermoplastic copolyester, thermoplastic polyamide, and thermoplastic vulcanates. Examples are PEBA, TPEE or COPE. Other suitable polymers could also be used.

The first polymer can be any suitable homopolymer, copolymer or blend thereof, and can be for example PET.

In one embodiment, the base material is a film having the first inner material formed of the first polymer mixed with the laser absorbing material as a first layer and the first outer material formed of the second polymer and the first blowing agent formed as a second layer that is located on the first layer. The base material could also be formed of a non-woven fabric in which at least some of the filaments are formed of the first polymer mixed with the laser absorbing material as the first inner material and the first outer material formed of the second polymer and the first blowing agent formed as a second layer or sheath that is located on the first inner material.

A preferred application of the industrial fabric is as a papermaking fabric and/or as a through-air dryer fabric.

In one embodiment, the protrusions are arranged in a repeating pattern on the first surface which forms a support surface. Here, the protrusions may be arranged in a repeating pattern on the first surface which forms a machine side surface.

In another aspect, an industrial fabric is provided having a base material that is formed continuously or has ends that are joined in order to form a belt having a first surface and a second surface. At least a portion of the base material at the first surface includes a first material formed of a first polymer and a first blowing agent. Protrusions extend from the first surface at selected locations, with the protrusions comprising an expanded part of the first material with a foamed or cellular structure created by the first blowing agent being activated in the first material.

In one arrangement, the protrusions are fully encapsulated between a solid portion of the first material that does not include the foamed or cellular structure.

In one embodiment, the first surface includes a first monofilament formed of the first polymer mixed with the first blowing agent, and the protrusions comprise an expanded portion of the monofilament with the foamed or cellular structure created by the first blowing agent being activated within the monofilament.

In another aspect, the industrial fabric may have at least a portion of the base material at the second surface including a second material formed of a third polymer mixed with a second blowing agent, and second protrusions extend from the second surface at selected second surface locations. The second protrusions comprise an expanded part of the second material with a foamed or cellular structure created by the second blowing agent being activated in the second material. It is possible for the first and the third polymers to be a same polymer, and the first and the second blowing agents to be a same blowing agent. It is also possible for second protrusions to just be formed by activating the first blowing agent at desired locations on the second surface of the base material.

In this embodiment, the first blowing agent can be a chemical blowing agent. It is also possible for the first blowing agent to be a physical blowing agent. The second blowing agent can be the same or different from the first blowing agent.

In another aspect, a method of forming an industrial fabric having a surface with a positive topographic form is provided. The method includes: (a) providing a base material that is formed continuously or has ends that are joined in order to form a belt having a first surface and a second surface, at least a portion of the base material at the first surface including a first inner material formed of a first polymer mixed with a laser absorbing material and a first outer material formed of a second polymer, and a first blowing agent located in at least one of the first inner material or the first outer material; and (b) applying energy at selected locations at the first surface of the base material to activate the first blowing agent in a region adjacent to form protrusions that extend from the first surface, the protrusions comprising an expanded part of the first outer material with a foamed or cellular structure created by the blowing agent.

The method can optionally further include encapsulating the protrusions between a solid portion of the first outer material that does not include the foamed or cellular structure and the first inner material.

The method can also be carried out substantially as described herein for a base material having the first surface including a first material formed of a first polymer mixed with a first blowing agent where the first polymer itself is laser absorbing and can generate heat, and the protrusions comprising an expanded part of the first polymer with a foamed or cellular structure are created by the blowing agent.

In one aspect, the applying energy includes applying a laser at the selected locations and generating heat by the laser energy being absorbed by the first inner material. Here, it is optionally possible for the laser to be activated based on a programmed pattern to apply the energy at the selected locations in order to form at least one of profiles or connected contours of the protrusions.

In one embodiment of the method, the laser can comprise a high-power near-infrared (NIR) lasers with digital light processing (DLP) technology, and the method can further include exposing a 2-dimensional area of the first surface with laser radiation in a single laser application, and controlling a height of the protrusions via grayscale imaging control of laser energy application to the first surface. This allows complex protrusion patterns to be formed in a faster manner than point-by-point laser-steering systems.

In one embodiment, the blowing agent is a heat activated chemical blowing agent that is activated at an activation temperature in a range from 160-350 °C, and the heat is generated in this range in a region of the first inner material and/or the first outer material at the interface between the first inner material and the first outer material.

A preferred application for the method is for making a papermaking fabric.

In one embodiment of the method, the base material is a fabric that includes a system of MD yarns connected, for example interwoven, to a system of CD yarns and is formed continuously or has ends that are joined in order to form the belt, and at least one of the CD yarns or the MD yarns include a core formed of the first polymer mixed with the laser absorbing material to form the inner material, and a sheath or layer formed of the second polymer and the first blowing agent to form the outer material.

In all of the embodiments of the industrial fabric, the first surface can be a machine side surface where the protrusions provide enhanced wear properties, or a support side surface where the protrusions can be used for various functions, such as adjusting the grip and release performance of the industrial fabric, for example for use in conveying applications. There is also particular interest in industrial fabrics that are papermaking fabrics and the protrusions are used to form a pattern in the paper product being carried or formed in order to provide water marks and/or increase bulk and/or absorbency. The use of industrial fabrics having protrusions of this type can be formed more efficiently in a wide array of patterns more efficiently and/or at lower cost.

In the embodiments with systems of CD and MD yarns, the base fabric can be woven or non-woven.

In one embodiment, the industrial fabric is a papermaking fabric. More preferably, the fabric is a TAD fabric, and the topographic pattern enhances the bulk and absorbency of the tissue or paper towel product that is carried on the support surface. Using this fabric, bulk and absorbency can be increased without spending high capital to rebuild existing wet crepe machines. Further, this allows bulk to be created in the forming section without having to press it in (using press felt and suction pressure roll) and avoids the disadvantage of pressing which densifies the sheet, removes bulk and decreases absorbency. Using the present industrial fabric as a forming fabric allows the imparting of topography to the sheet, while still maintaining the other critical performance characteristics of the forming wire (fiber support, good drainage, etc.).

Additionally, the present industrial fabric when used as a forming fabric, can be used to create drainage marks. After the foil section on the forming table, in many cases the forming fabric passes over a series of vacuum boxes and then over a couch roll. A dandy roll is located on top of the forming fabric over the suction boxes. This is a light open structured roll covered with wire cloth, resting lightly upon the surface of the sheet. Its function is to flatten the top surface of the sheet and improve the finish. A pattern on the dandy roll may leave translucent patterns on the wet paper, in the form of names, insignia or designs, called watermark. Using the present industrial fabric, watermark designs may be created with the forming fabric.

Other applications for the industrial fabric according to the invention are as a conveyor belt. Here the surface topography can be used to adjust the grip and release performance of the conveyor belt. In applications, such as the formation of spun bond and melt blown nonwoven materials, the topography of the support side of the industrial fabric can be tuned to obtain the best balance of grip and release performance with the nonwoven product being formed and conveyed.

Preferably, the second polymer is thermoplastic elastomer (TPE) synthesized from homopolymer, copolymers or blending, and includes for example thermoplastic urethane (TPU), thermoplastic olefins, thermoplastic copolyester, thermoplastic polyamide, and thermoplastic vulcanates.: E.g. PEBA, TPEE or COPE, etc., could also be used.

The base fabric can also be formed of a Spunbond and Meltblown non-woven material including yarns having the core/sheath structure described above.

As a further alternative, the base material can be provided as a, preferably biaxially stretched, film. Here, the base material is formed continuously or has ends that are joined in order to form a belt having a first surface and a second surface, and at least a portion of the base material includes a first inner material, which can be a first film layer, formed of a first polymer and a first outer material, which can be a second film layer or coating, formed of a second polymer and a first blowing agent located on the first inner material. The base material may be structured, for example punched or otherwise have holes defined therein, to provide a desired permeability. Protrusions extend from the first surface at selected locations, with the protrusions comprising an expanded part of the first outer material with a foamed or cellular structure created by the first blowing agent being activated in a region adjacent to the first inner material that is fully encapsulated by a solid portion of the first outer material that does not include the foamed or cellular structure and the first inner material.

In a preferred embodiment, the protrusions are arranged in one or more repeating patterns on the support surface. Here, a repeating pattern includes patterns that may have some variation depending on where certain features at the first and/or second surfaces of the base material occur, such as knuckles if the base material is a woven fabric, or where spaces occur between CD and/or MD yarns. Variations would also occur for non-wovens that are Spunbound or Meltblown, depending on where the chopped fibers or yarns are located. Variations can also occur due to the structuring provided for a film used as the base material. All such variations are encompassed within the meaning of the term “repeating pattern” as used herein.

In one embodiment for a base material being formed of the fabric with the system of MD yarns connected to a system of CD yarns, only the at least some of the CD yarns include the core formed of the first polymer mixed with a laser absorbing material, such as carbon black, and the sheath is formed of the thermoplastic polyurethane (TPE) and the chemical blowing agent, and the MD yarns do not include any TPU, and can be for example monofilaments.

In one embodiment, the first and/or second blowing agent is a chemical blowing agent and is heat activated, preferably using laser energy that is absorbed by the core in a yarn arrangement or the first inner material in a first film layer in the film arrangement in order to reach an activation temperature for the chemical blowing agent in the region of the sheath adjacent to the core in a yarn arrangement or the second outer material in the second film layer or coating in the film arrangement.

In one preferred arrangement, the first blowing agent is a chemical blowing agent and is heat activated at an activation temperature in a range from 160-350 °C. Alternatively, the first blowing agent can be a physical blowing agent, such as trapped liquid particles that can also be heat activated.

In one alternative embodiment, the sheath (or second film layer or coating) comprises an inner portion formed of the second polymer and the first blowing agent and an outer portion formed of the second polymer or another polymer without any chemical blowing agent. The second polymer is also preferably TPU.

In a preferred embodiment of the base material that is a fabric, the CD yarns are arranged as individual filaments. However, multi-filament arrangements could also be utilized.

In another aspect, a method of forming an industrial fabric having a surface with a positive topographic form is provided. The method comprises:
(a) providing a base material that is formed continuously or has ends that are joined in order to form a belt having a first surface and a second surface, at least a portion of the base material at the first surface including a first inner material formed of a first polymer mixed with energy absorbing material and a first outer material formed of a second polymer and a first blowing agent located on the first inner material; and
(b) applying energy at selected locations at the first surface of the base material to activate the first blowing agent in a region adjacent to the first inner material to form protrusions that extend from the first surface, the protrusions comprising an expanded part of the first outer material with a foamed or cellular structure created by the blowing agent in the region adjacent to the first inner material that is fully encapsulated by a solid portion of the first outer material that does not include the foamed or cellular structure and the first inner material.

In one embodiment of the method, the applying energy includes applying a laser at the selected locations and generating heat by the laser energy being absorbed by the first inner material, which can be the core for when the base material is formed by systems of yarns or non-wovens made of yarns or filaments or can be the first film layer for a base material formed as a film.

This method can also be carried out substantially as described herein for a base material having the first surface including a first material formed of a first polymer mixed with a first blowing agent where the first polymer itself is laser absorbing and can generate heat, and the protrusions comprising an expanded part of the first polymer with a foamed or cellular structure are created by the blowing agent.

The laser energy can be applied by one or more lasers moving along one or multiple paths, with either intermittent or constant energy being applied. Alternatively, as discussed above, industrial systems using high-power near-infrared (NIR) lasers with digital light processing (DLP) technology can be used in which a 2-dimensional area is exposed to laser radiation in one shot. This enables complex image printing more quickly than point-by-point laser-movement control systems. DLP technology also enables grayscale imaging for multi-bit depth/height differentiation by programming the micromirrors on- and off-time. This can be used to set and/or control the height of the protrusions in order to provide different profiles on the base material.

In one embodiment, the blowing agent is a chemical blowing agent that is heat activated at an activation temperature in a range from 160-350 °C, and the heat is generated in this range in the region of the sheath adjacent to the core for embodiments in which the base material is a fabric with one or more yarn systems.

In one preferred arrangement, the laser is activated based on a programmed pattern to apply the energy at the selected locations in order to form at least one of profiles or connected contours or patterns of the protrusions. For example, a laser or lasers can be mounted on a linear actuator that is movable in the CD across a width of the fabric, and can be indexed to different CD positions and activated to form one or more protrusions prior to indexing the fabric forward in the MD and repeating the process at the desired locations in order to create a desired topographical pattern of the protrusions. This avoids the need for complex weave patterns of the MD and CD yarn systems in order to create a topography of projections and pockets based only on the weave pattern or laminating of a further material having a specific topography on top of the base fabric.

In one application, the method is for making a papermaking fabric, and more preferably is for making a TAD fabric.

In one arrangement, the sheath comprises an inner portion formed of the TPE and the chemical blowing agent and an outer portion formed of a second polymer (which can also be TPE) without any chemical blowing agent, and applying the energy at the selected locations at the support surface of the base fabric activates the chemical blowing agent of the inner portion in order to form the protrusions.

In another aspect, an industrial fabric is provided in which the base material that is formed continuously or has ends that are joined in order to form a belt having a first surface and a second surface. At least a portion of the base material includes a first inner material formed of a first polymer as well as a first outer material formed of a second polymer and a first blowing agent located on the first inner material. The first inner material and the first outer material may be structured as noted above as either formed from one or more yarn systems or as film layers. However, instead of having the core or first film layer being used to generate heat, for example by the addition of carbon black, the first outer material is energy absorbing so that the first blowing agent can be activated via heat directly absorbed by the first outer material. Protrusions extend from the first surface at selected locations, with the protrusions comprising an expanded part of the first outer material with a foamed or cellular structure created by the first blowing agent being activated. In this case, the first inner material is used for mechanical properties of the industrial fabric.

In accordance with the present disclosure, as noted above the blowing agent can be a chemical blowing agent (CBA) or a physical blowing agent (PBA) such as N2, CO2, butane, water, etc. The solubility and diffusivity of the blowing agent in the polymer determines if this is possible and the effectiveness of a PBA as the blowing agent. For example, some research has shown that a TPU can be foamed by water or water+CO2 to provide ultra-cellular foams. PBAs may also be possible for foaming polyamides.

It may also be possible to use aromatic TPU or other types of TPUs or even water as the blowing agent. A TPU selected so that it would rapidly absorb water such that it has a certain amount of mass of water absorbed in the sheath or first outer layer can then have localized areas exposed to heat and the absorbed water vaporizes and act as a physical blowing agent. Here parts that have absorbed water that are not exposed to laser don't foam.

One expected benefit of the present disclosure is the ability to maintain high air permeability after structuring of the base material using a blowing agent to create encapsulated foamed areas or regions. No additional material needs to be added (i.e., applied on the surface) of the base material to produce the desired topographical protrusions.

A particular benefit in TAD and other papermaking fabrics is that the resistance to air and vapour mass flow in the z-direction (thickness direction) and xy-plane is reduced, and should increase drying rates.

While several features are noted in connection with the disclosed embodiments, one or more of these features can be combined and utilized in order to provide an industrial fabric, and in particular a TAD fabric, with a topographic form on the support surface (as the first surface) with much greater flexibility in defining the specific topography.

### BRIEF DESCRIPTION OF THE DRAWINGS

The foregoing summary as well as the following detailed description will be best understood when read in conjunction with the appended drawings. In the drawings:

FIG. 1 is a cross-sectional view through a first embodiment of a yarn used in an industrial fabric according to the present disclosure

FIG. 2 is a cross-sectional view through a second embodiment of a yarn used in an industrial fabric according to the present disclosure.

FIG. 3 is an enlarged detail taken at the indicated area in FIG. 1 showing a portion of the first outer material, here shown as a sheath, and the first inner material, shown as a core, at a selected location with a superimposed temperature profile that can be achieved through the portion of the sheath and core upon application of laser energy at the selected location on the yarn which is absorbed by the core in order to generate a peak heat at a region where the core contacts the sheath.

FIG. 4 is an enlarged view similar to FIG. 3 showing a cross-section through the yarn after activation of a blowing agent in the first outer material, here the sheath, preferably by laser generated heat, in order to form a protrusion that includes expanded first outer material with a foamed or cellular structure created by the blowing agent being activated in the region adjacent to the first inner material, with the protrusion preferably being fully encapsulated by a solid sheath material surface of the sheath that does not include the foamed or cellular structure.

FIG. 5 is a schematic view showing a portion of the support surface of the industrial fabric formed of MD yarns and CD yarns in which protrusions are formed in a topographical pattern (two different exemplary patterns are shown) on at least some of the CD or MD yarns, with the topographical pattern being programmable by selecting the positions for activation of the blowing agent at select locations where the energy is applied to the support surface of the base fabric in order to activate the blowing agent in the sheath to form an arrangement of protrusions.

FIG. 6 is a schematic view showing the base fabric formed continuously or having ends that are joined in order to form a continuous belt having the support surface.

FIG. 7 is a cross-sectional view through a third embodiment of a yarn having a rectangular cross-section and including a first inner material formed of a first polymer mixed with a laser absorbing material and a first outer material formed of a second polymer, and a first blowing agent located in (or mixed with) the second outer material, with the yarn being used in an industrial fabric according to the present disclosure.

FIG. 8 is a cross-sectional view through the third embodiment of the yarn shown in FIG. 7 after activation of a blowing agent in the first outer material, preferably by laser generated heat, in order to form a protrusion that includes expanded first outer material with a foamed or cellular structure created by the blowing agent being activated in the region adjacent to the first inner material, with the protrusion preferably being encapsulated at least on the upper surface by a solid material surface of the first outer material that does not include the foamed or cellular structure.

FIG. 9 is a cross-sectional view through a fourth embodiment of a yarn having a circular cross-section and including a first material formed of a first polymer mixed with a first blowing agent, with the yarn being used in an industrial fabric according to the present disclosure.

FIG. 10 is a cross-sectional view through the fourth embodiment of the yarn shown in FIG. 9 after activation of a blowing agent in the first material, preferably by laser generated heat, in order to form a protrusion that includes expanded first material with a foamed or cellular structure created by the blowing agent being activated.

FIG. 11 is a cross-sectional view through a fifth embodiment of a yarn having a rectangular cross-section and including a first material formed of a first polymer mixed with a first blowing agent, with the yarn being used in an industrial fabric according to the present disclosure.

FIG. 12 is a cross-sectional view through the fifth embodiment of the yarn shown in FIG. 11 after activation of a blowing agent in the first material, preferably by laser generated heat, in order to form a protrusion that includes expanded first material with a foamed or cellular structure created by the blowing agent being activated.

FIG. 13 is a cross-sectional view through a sixth embodiment of a yarn having a circular cross-section and including a first material formed of a first polymer mixed with a first blowing agent, and a first outer material formed of a second polymer, with the yarn being used in an industrial fabric according to the present disclosure.

FIG. 14 is a cross-sectional view through the sixth embodiment of the yarn shown in FIG. 13 after activation of the blowing agent in the first material, preferably by laser generated heat, in order to form a protrusion that includes expanded first material with a foamed or cellular structure created by the blowing agent being activated in the region adjacent to the first inner material, with the protrusion preferably being encapsulated at least on the upper surface by a solid material surface of the first outer material.

FIG. 15 is a view of a first surface of an industrial fabric made from interwoven systems of MD and CD yarns showing a pattern applied by a laser for heat-activating a blowing agent in the first outer material of the CD yarns to form protrusions in a topographical pattern on the first surface.

FIG. 16 is an enlarged view of the first surface of the industrial fabric shown in FIG. 15 showing the occurrence of some variations in the topographical pattern of protrusions that are formed by the laser heat-activation of the blowing agent in the sheath of the CD yarns due to the positions of the yarns in comparison to the pattern used for activation.

FIG. 17 is an enlarged view of a portion of an industrial fabric end that includes a separately attached seam component.

FIG. 18 is a view similar to FIG. 17 showing protrusions formed in a pattern on the seam component by having a layer of the second polymer mixed with a blowing agent as an outer layer on the seam component, and the blowing agent being activated in order to produce the protrusions, for example through heat activation via application of a laser in a desired pattern.

FIG. 19 is a perspective view of a portion of an industrial fabric formed from a structured non-woven film, for example made from biaxially-oriented polyethylene terephthalate (BoPET).

FIG. 20 is a cross-sectional view through the structured non-woven film of FIG. 19 showing a coating or co-extruded layer formed of the second polymer mixed with a blowing agent as an outer layer.

FIG. 21 is a perspective view similar to FIG. 19 showing protrusions formed in a pattern on the first surface of the structured non-woven film by the blowing agent being activated in order to produce the protrusions, for example through heat activation via application of a laser in a desired pattern.

FIG. 22 is a cross-sectional view through the structured non-woven film of FIG. 21 showing the protrusion formed in the outer layer.

FIG. 23 is a view of a first surface of an industrial fabric made from interwoven systems of MD and CD yarns showing another pattern applied by a laser for heat-activating a blowing agent in the first outer material of the CD yarns to form protrusions in a topographical pattern on the first surface.

FIG. 24 is a view of a first surface of an industrial fabric made from interwoven systems of MD and CD yarns showing a further pattern applied by a laser for heat-activating a blowing agent in the first outer material of the CD yarns to form protrusions in a topographical pattern on the first surface.

FIG. 25 is a cross-sectional view through a portion of a base fabric formed of systems of MD and CD yarns having protrusions formed on the first surface and the second surface.

FIG. 26 is cross-sectional view through a rectangular monofilament in which both the first and second surfaces have respective protrusions

### DETAILED DESCRIPTION

Certain terminology is used in the following description for convenience only and is not limiting. The fabric according to the invention is an industrial textile, preferably a papermaking fabric, and more preferably a TAD fabric. However, in some embodiments it can have many industrial applications, such as conveyor belts, belts for pulp and filtration applications, etc. The fabric can be woven or non-woven or formed of a structured film, and this term is used with a broad meaning. The words “support side” and “machine side” designate surfaces of the fabric with reference to their use in one preferred application in a conveying application; however, these terms merely represent first and second or upper and lower surfaces of the planar fabric. “Yarn” is used to generically identify a monofilament or multifilament fiber. “Warp” and “weft” are used to designate yarns or monofilaments based on their position in the loom that extend in perpendicular directions in the fabric and either could be a machine direction (MD) or cross-machine direction (CD) yarn in the fabric once it is installed on a piece of equipment, depending on whether the fabric is, for example, flat woven or continuously woven. In one preferred arrangement, the fabric can be flat woven and seamed at the warp ends in order to form a continuous belt, so that the warp yarns are MD yarns and the weft yarns are CD yarns. The base fabric could also be continuously woven, in which case, the weft yarns would extend in the MD and the warp yarns would extend in the CD. The base fabric could also be a multiaxial fabric assembled from a strip of fabric having a narrower width that is wound around two spaced-apart rolls at an angle to the MD, with the longitudinal edges being joined together to form a wider fabric belt. The strip could be a woven strip or a nonwoven strip. For the multiaxial arrangement, the MD and CD yarns would be canted with respect to a true MD and a true CD by about 1° to 7°. However, for this disclosure, this is encompassed within the reference to MD and CD yarns. Regardless of how the base fabric is made, the designations of warp, weft and/or MD and CD as used in the description that follows can be interchanged. Further, for non-woven fabrics, these may be formed of spunbond or meltblown chopped fibers that would have no specific orientation. Further, the base fabric can be a film, preferably a BoPET film, that may have punched openings that can be folded over and laminated to provide more body as well as to adjust permeability.

Blowing agents are defined as compounds which are thermally unstable and decompose to yield gas or otherwise expand (such as water turning to steam) at the desired polymer processing temperature. One example of a chemical blowing agent is Azodicarbonamide (ADC), which is a known industrial blowing agent. Pure ADC decomposes between 200-210 °C. Certain activating agents can be added to ADC to lower its decomposition temperature down to 150 °C or even lower. A physical blowing agent is water, which can be absorbed or dispersed in a material which expands as it turns to steam when heated.

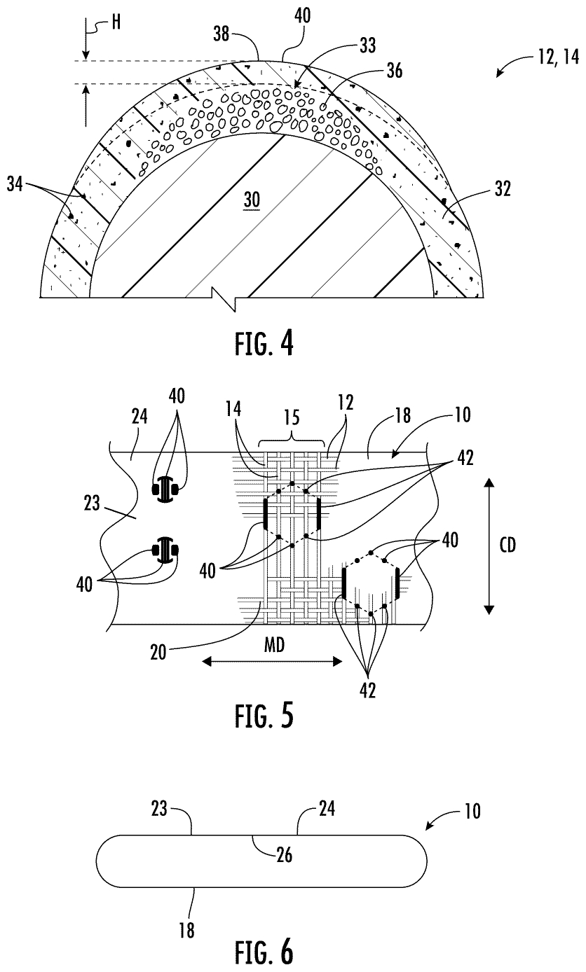

A positive topographic form refers to protrusions formed on a surface of a fabric that extend beyond a nominal surface (for example by a distance H shown in FIG. 4) created by interweaving or otherwise joining together MD and CD yarns, or extends a nominal surface of a nonwoven fabric or film.

In describing different embodiments of the fabric assemblies like element numbers are used for elements having the same function, even if there are minor differences in shape, for example, yarns having different cross-sections.

Referring to FIGS. 5 and 6, an industrial fabric 10 according to a first embodiment is provided. The industrial fabric 10 includes a system of MD yarns 12 connected to a system of CD yarns 14 to form a base fabric 20 as a base material 18, that is formed continuously or has ends that are joined in order to form a belt 23 having a first surface 24, which can be a support surface, and a second surface 26, which can be a machine side surface. The MD yarns 12 and CD yarns 14 can be interwoven or joined in another manner, for example, using an adhesive in order to form the base fabric 20. To the extent that the MD yarns 12 and CD yarns 14 are continuously woven, no seam would be required. Alternatively, if the MD yarns 12 and the CD yarns 14 are flat woven, then a seam would be required as would be known to those of ordinary skill in the art. The base fabric 20 could also be formed as a spirally wound fabric as defined above with MD yarns 12 and CD yarns 14.

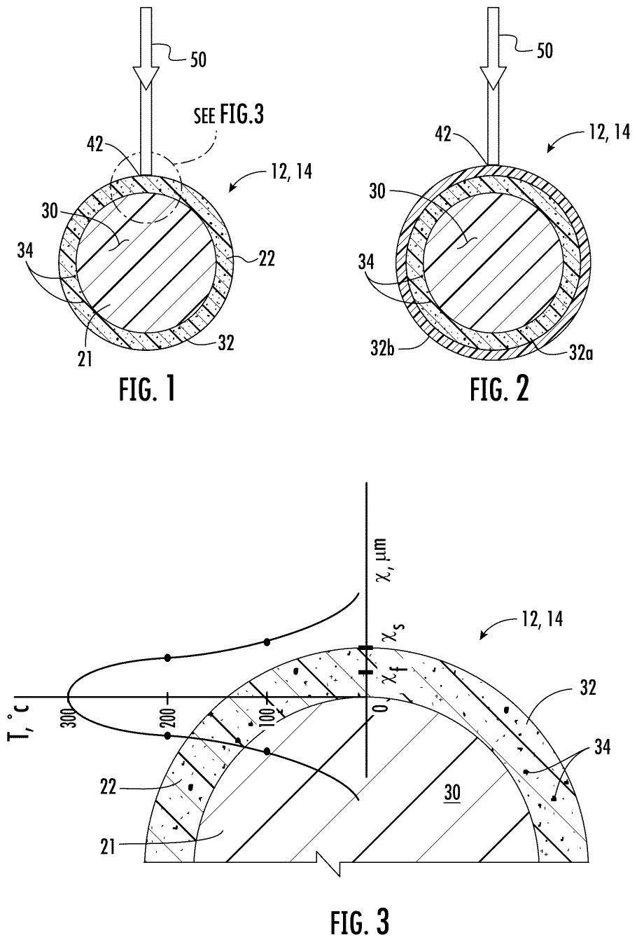

Referring now to FIGS. 1-4, at least some of the CD yarns 14 and/or the MD yarns 12 include a core 30 (more generally, a first inner material 21) formed of a first polymer, which can be, for example, PET or any other suitable polymer, that is mixed with carbon black or any other suitable laser absorbing material that absorbs heat when exposed to certain types of energy, for example a laser. A sheath or layer 32 (more generally, a first outer material 22) is formed of a second polymer, such as thermoplastic polyurethane (TPU), homopolymer, block copolymers or blends, e.g. PEBA, TPEE or COPE, and a blowing agent 34 is formed on or at least partially around the core 30, for example by co-extruding. While TPU is preferred, other polymers could also be used.

The blowing agent 34 can be a chemical blowing agent as discussed above. However, other chemical blowing agents which, when incorporated into a polymeric material, form a foamed or cellular structure when activated, for example by heat, could also be used, including physical blowing agents. In the preferred embodiment, the chemical blowing agent 34 is used and is heat activated, and more preferably, the chemical blowing agent 34 is heat activated at an activation temperature T in the range of 160-350 °C.

As shown in FIG. 1, the sheath or layer 32 can be formed as a single layer with the mixture of the second polymer and the blowing agent 34. Alternatively, as shown in FIG. 2, the sheath or layer 32 can comprise an inner portion 32a formed of the second polymer and the blowing agent 34 and an outer portion 32b formed of the second polymer (or another polymer) without any of the blowing agent. In a preferred arrangement, the same second polymer is used. The inner portion 32a and the outer portion 32b can be coextruded on the core 30.

As shown in detail in FIG. 4, protrusion(s) 40 formed by activation of the blowing agent 34 at select locations 42 extend from at least some of the CD yarns 14 and/or the MD yarns 12 (indicated in FIG. 5) on the first surface 24. Activation of the blowing agent 34 can be via laser energy being applied and building up heat as shown by the superimposed temperature profile in FIG. 3 so that an activation temperature, for example above 160 °C, can be achieved through the portion of the sheath or layer 32 and core 30 at the selected location on the yarn based on energy absorbed by the core 30 to generate a peak heat at a region where the core 30 contacts the sheath or layer 32.

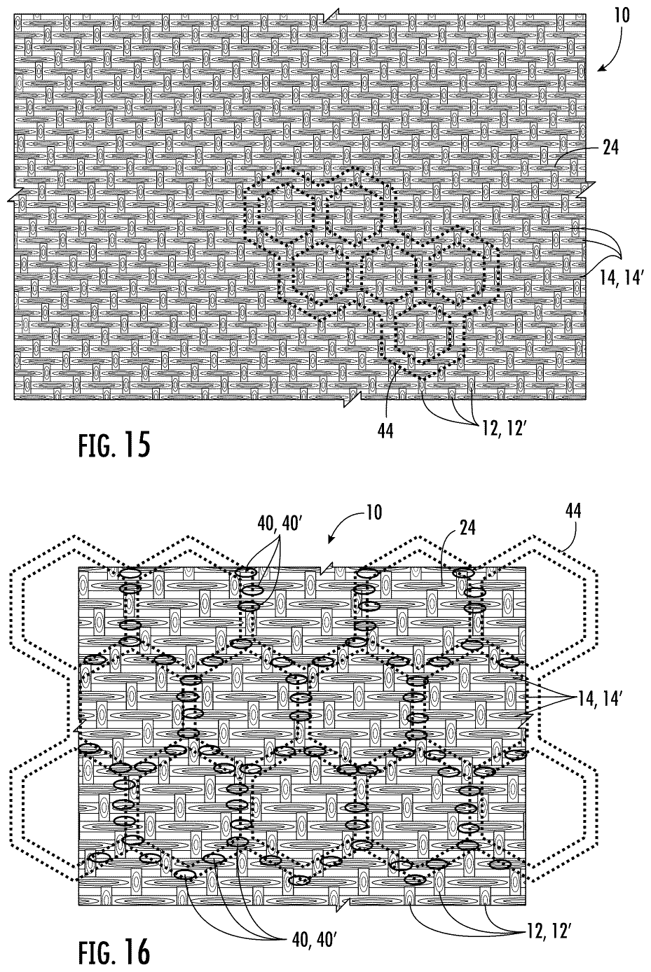

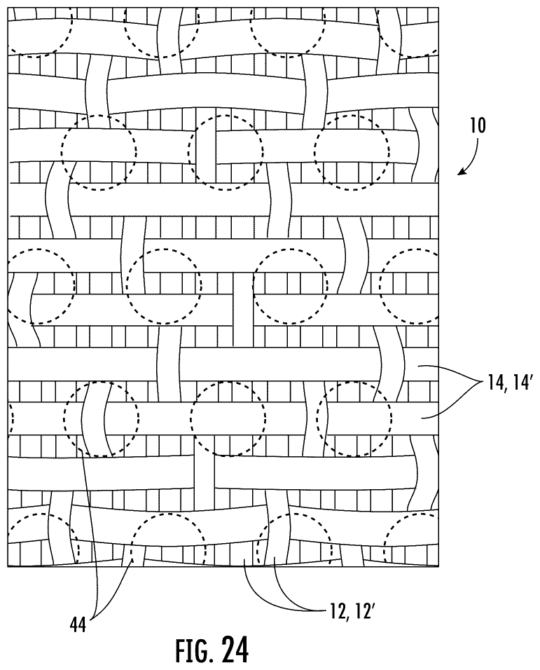

As shown in FIG. 4, these protrusions 40 comprise an expanded first outer or sheath material 33 with a foamed or cellular structure 36 created by the chemical blowing agent 34 being activated in a region of the sheath 32, 32a adjacent to the core 30 that is preferably fully encapsulated by a solid sheath material surface 38 of the sheath 32, 32b that does not include the foamed or cellular structure 36. As shown, for example, in FIGS. 15, 23, and 24, these protrusions 40 are arranged in a repeating pattern on the support surface 24. FIG. 5 shows two different exemplary patterns, with one pattern forming a hexagonal raised shape across a group 15 of 5 of the CD yarns 14 with a non-raised center to form a pocket, and the other being an enlarged protrusion formed on 3 adjacent CD yarns. However, the size, shape, and spacing of the patterns is not limited to the examples shown, and could take various forms, including figures, shapes, characters, or drawings, for example as shown in FIGS. 23 and 24. Additionally, the protrusions can be on the first surface 24 and/or the second surface 26. If the first surface 24 is the support surface, the pockets can be used for bulk enhancement during tissue formation. If the first surface is the machine side surface, the protrusions 40 can be used for wear protection.

In one preferred arrangement, only the at least some of the CD yarns 14 include the core 30 formed of a first polymer mixed with carbon black or other laser absorbing material and the sheath or layer 32 or inner portion 32a thereof formed of the second polymer and the chemical blowing agent 34. Here, the CD yarns 14 are preferably arranged as individual filaments, rather than being a multifilament. This arrangement is useful in connection with providing a papermaking fabric 10, particularly for a TAD fabric, having protrusions 40 arranged as profiles, patterns, or connected contours in order to form a repeating topography in a simple and efficient manner that can be easily changed by simply programming a different pattern for the selected locations 42 where energy is applied, preferably in the form of a laser beam, in order to activate the chemical blowing agent 34 and form the protrusions 40.

Alternate configurations of the CD and/or MD yarns 12, 14; 12′, 14′ are shown in FIGS. 7-14. The alternate configurations of the CD and/or MD yarns 12, 14; 12′, 14′ have the same types of protrusions 40, 40′ formed of a foamed or cellular structure 36 created by the chemical blowing agent 34, present in the core 30, 30′ and/or the sheath or layer 32, 32′ thereon being activated. The CD and/or MD yarns 12′, 14′ have a rectangular cross-section and the CD and/or MD yarns 12, 14 have a round cross-section. Other cross-sections are possible. Further differences in the additional embodiments are described below. These embodiments, as well as the above-described embodiment could also be used in non-woven material as some or all of the filaments used to form the non-woven.

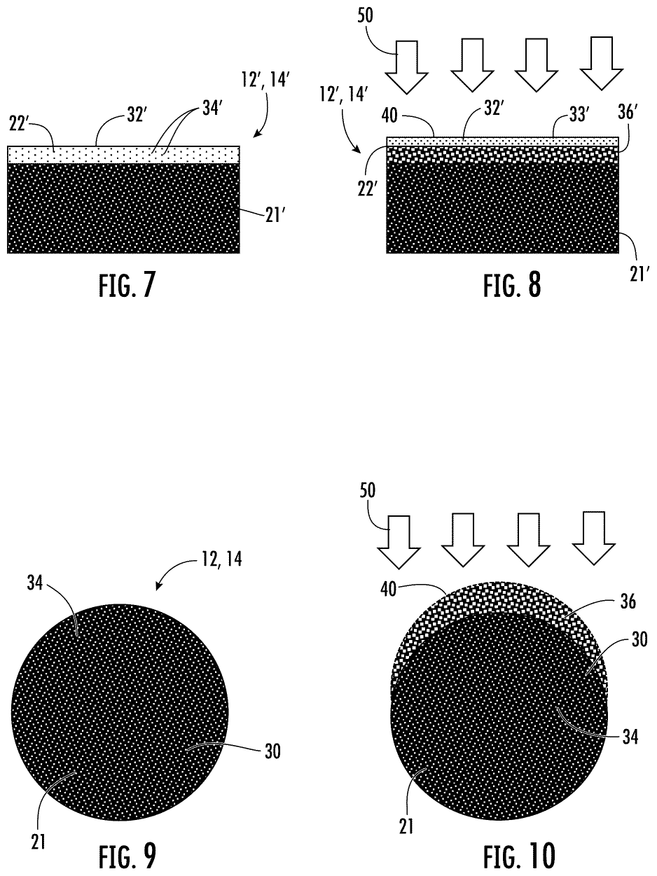

FIGS. 7 and 8 show a third embodiment of a monofilament yarn, which can be a CD and/or MD yarn 12′, 14′ having a rectangular cross-section and including a first inner material 21′ formed of a first polymer, which can be, for example, PET or any other suitable polymer, that is mixed with carbon black or any other suitable laser absorbing material that absorbs heat when exposed to certain types of energy, for example a laser. A first outer material 22′ in the form of a layer is formed of a second polymer, such as a thermoplastic elastomer (TPE) synthesized from homopolymer, copolymers or blending, and includes for example thermoplastic urethane (TPU), thermoplastic olefins, thermoplastic copolyester, thermoplastic polyamide, and thermoplastic vulcanates., e.g. PEBA, TPEE or COPE, and a blowing agent 34′, which may be as discussed above, is formed on or at least partially around the inner material 21′, for example by co-extruding. In the illustrated embodiment, the first outer material 22′ is only on an upper surface of the first inner material 21′; however, it could surround the entire first inner material 21′. While TPU is preferred for the first outer material 22′, other polymers could also be used.

As shown in FIG. 8, applying a laser 50 at the selected locations and generating heat by the laser energy being absorbed by the first inner material 21′ based on the inclusion of the carbon black or other laser absorbing material generates heat that activates the blowing agent 34′ to form a foamed or cellular structure 36′ that creates the protrusion(s) 40′ with the expanded first outer material 33′. The protrusion(s) 40′ can be in patterns as discussed above.

FIGS. 9 and 10 show a fourth embodiment of a monofilament yarn, which can be a CD and/or MD yarn 12, 14, having a round cross-section and including a first inner material 21 formed of a first polymer, which can be any suitable polymer, that is mixed with carbon black or any other suitable laser absorbing material that absorbs heat when exposed to certain types of energy, for example a laser, and a blowing agent 34.

As shown in FIG. 10, applying a laser 50 at the selected locations and generating heat by the laser energy being absorbed by the first inner material 21 based on the inclusion of the carbon black or other laser absorbing material generates heat that activates the blowing agent 34 to form a foamed or cellular structure 36 in the first inner material that creates the protrusion(s) 40. The foamed or cellular structure 36 of the protrusion(s) 40 can be fully encapsulated between a solid portion of the first material 21 that does not include the foamed or cellular structure 36.

The protrusion(s) 40 can be in patterns as discussed above.

FIGS. 11 and 12 show a fifth embodiment of a monofilament yarn, which can be a CD and/or MD yarn 12′, 14′, having a rectangular cross-section and including a first inner material 21′ formed of a first polymer, which can be any suitable polymer, that is mixed with carbon black or any other suitable laser absorbing material that absorbs heat when exposed to certain types of energy, for example a laser, and a blowing agent 34′.

As shown in FIG. 12, applying a laser 50 at the selected locations and generating heat by the laser energy being absorbed by the first inner material 21′ based on the inclusion of the carbon black or other laser absorbing material generates heat that activates the blowing agent 34′ to form a foamed or cellular structure 36′ in the first inner material that creates the protrusion(s) 40′. The protrusion(s) 40′ can be in patterns as discussed above.

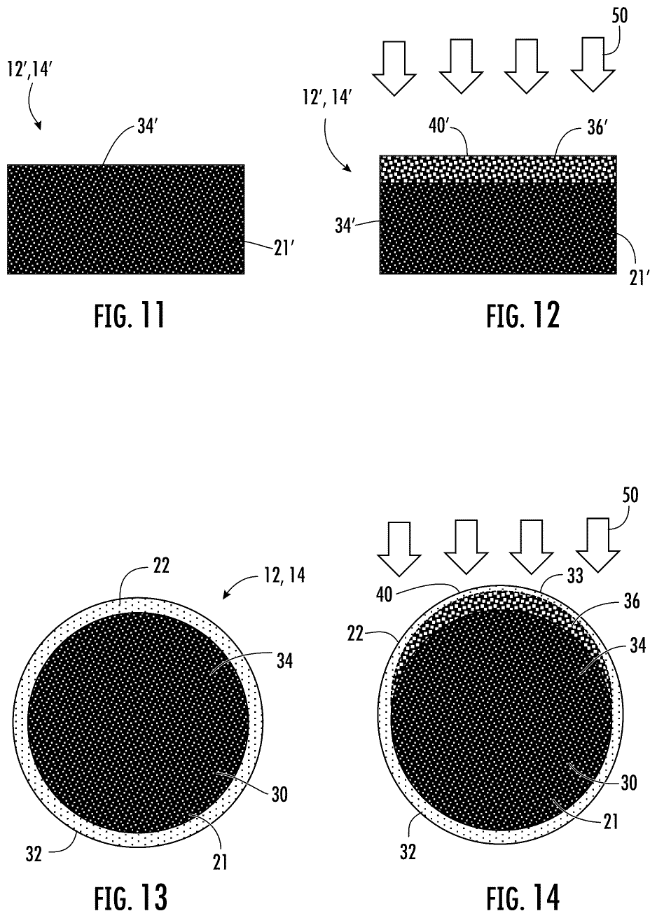

FIGS. 13 and 14 show a sixth embodiment of a monofilament yarn, which can be a CD and/or MD yarn 12, 14 a having a round cross-section and including a first inner material 21 formed of a first polymer, which can be, for example, PET or any other suitable polymer, that is mixed with carbon black or any other suitable laser absorbing material that absorbs heat when exposed to certain types of energy, for example a laser, and a blowing agent 34. Depending on the first polymer, the carbon black or other laser absorbing material additive can be omitted if the first polymer itself is laser energy absorbing in order to generate heat. A first outer material 22 in the form of a layer is formed of a second polymer, such as a thermoplastic elastomer (TPE) synthesized from homopolymer, copolymers or blending, and includes for example thermoplastic urethane (TPU), thermoplastic olefins, thermoplastic copolyester, thermoplastic polyamide, and thermoplastic vulcanates., e.g. PEBA, TPEE or COPE, is formed on or at least partially around the inner material 21, for example by co-extruding. In the illustrated embodiment, the first outer material 22 is in the form of a sheath and surrounds the first inner material 21 which is in the form of a core 30. However, it is also possible to provide only an upper surface of the first inner material 21 having a layer of the first inner material 21.

As shown in FIG. 14, applying a laser 50 at the selected locations and generating heat by the laser energy being absorbed by the first inner material 21 based on the inclusion of the carbon black or other laser absorbing material, or based on the properties of the first polymer itself, generates heat that activates the blowing agent 34 to form a foamed or cellular structure 36 which in this case is in the first inner material 21 that creates the protrusion(s) 40 with the expanded first outer material 33. The protrusion(s) 40 can be in patterns as discussed above.

Referring to FIGS. 15 and 16, FIG. 15 shows a first surface 24 of the industrial fabric 10 with a hexagonal pattern (indicated as 44) for activation of the blowing agent 34, 34′ in the CD yarns 14, 14′ using a laser in a repeating pattern. FIG. 16 illustrates that the repeating pattern of the protrusions 40, 40′ may have some variations depending on how the hexagonal pattern 44 intersects with the CD yarns 14, 14′; however, this is still referred to as a repeating pattern of the protrusions 40, and such variations are encompassed within this disclosure. This would similarly apply to arrangement in which the MD yarns 12, 12′ or both the CD yarns 14, 14′ and the MD yarns 12, 12′ include the first inner material 21, 21′ formed of a first polymer mixed with carbon black and the first outer material 22, 22′/sheath 32 or inner portion 32a thereof formed of the second polymer and the blowing agent 34, and/or the arrangements in which the yarns 12, 12′; 14, 14′ are formed with just the first inner material 21, 21′ including the blowing agent 34.

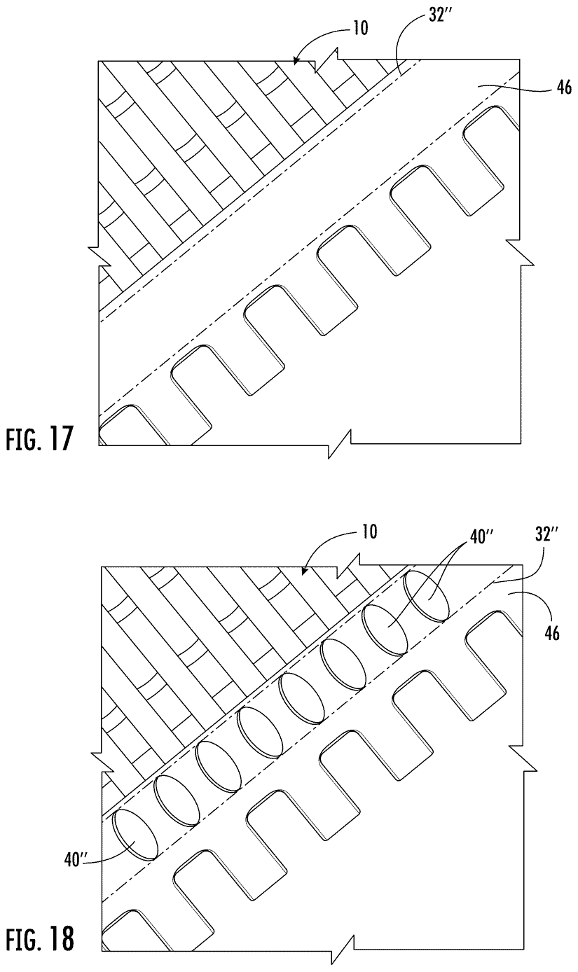

Referring to FIGS. 17 and 18, a layer 32″ formed of the second polymer mixed with the blowing agent 34 is applied to a seam component 46 used to connect ends of the industrial fabric 10 together in order to form an endless loop. As shown in FIG. 10, protrusions 40″ are formed in a pattern on the seam component upon being activated, for example through heat activation via application of a laser in a desired pattern. This allows a desired topography to be added to the seam component 46.

For an industrial fabric formed as a nonwoven mesh that is spunbonded or meltblown, some or all of the fibers used could be formed with the first inner material 21, 21′ formed of a first polymer mixed with carbon black or another laser absorbing material and the first outer material 22, 22′, which can be in the form of a layer or outer sheath 32 or an inner portion 32a of the outer sheath 32 formed of the second polymer and the blowing agent 34 as described above and shown in FIGS. 1-3. Here the first surface 24 and/or the second surface 26 can be activated, for example via a laser, at select locations such that the blowing agent 34 expands to form the protrusions on one or both of the first or second surfaces 24, 26. One or more of the other embodiments of the monofilament yarns described above could also be used to form a nonwoven mesh.

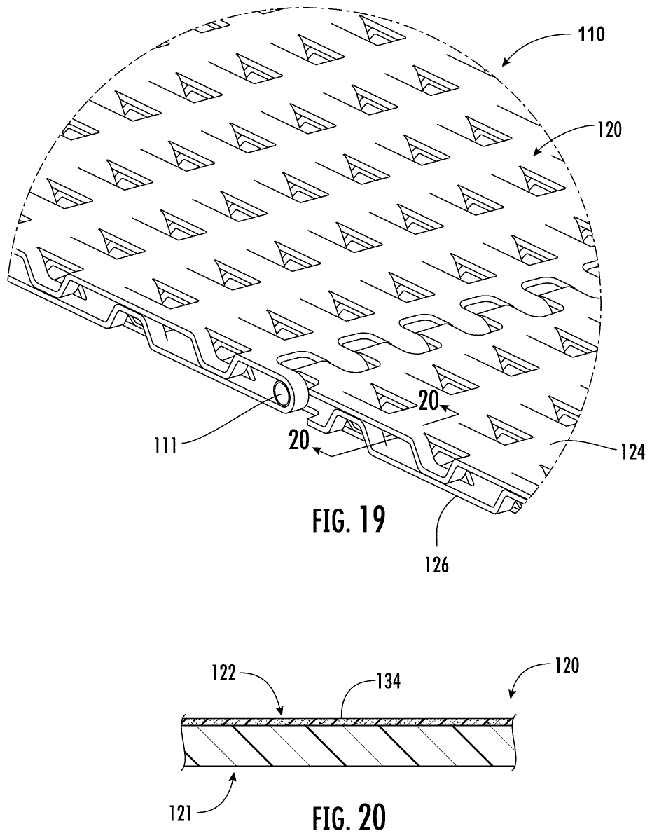

Referring now to FIGS. 19-22, a further embodiment of an industrial fabric 110 is shown. The industrial fabric 110 includes a base material 120 that is provided as a, preferably biaxially stretched, film. Here, the base material 120 is formed continuously or has ends that are joined in order to form a belt (similar to the belt 23 in FIG. 6) having a first surface 124 and a second surface 126. The film can be structured with punched portions that define openings as well as a depth if the film is folded back on itself as shown in FIG. 19 wherein the folded over ends define loops that are interdigitated and connected by a pintle 111. As shown in FIG. 20, at least a portion of the base material 120 includes a first inner material 121, which can be a first film layer, formed of a first polymer, and a first outer material 122, which can be a second film layer or coating, formed of a second polymer and a blowing agent 134 located on the first inner material 121. Here the first and second polymers can be as described above. The blowing agent 134 is preferably a chemical or physical blowing agent as described above.

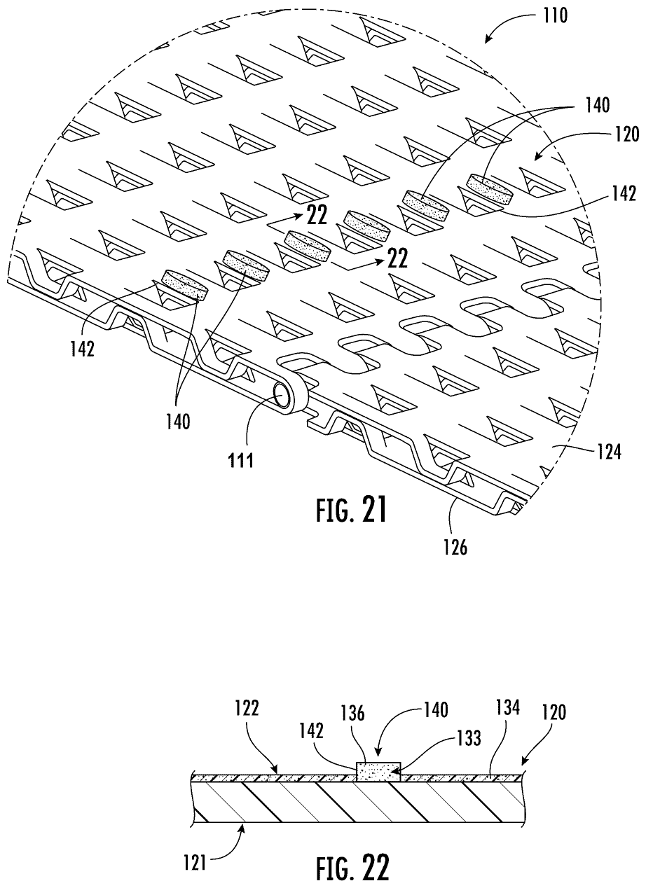

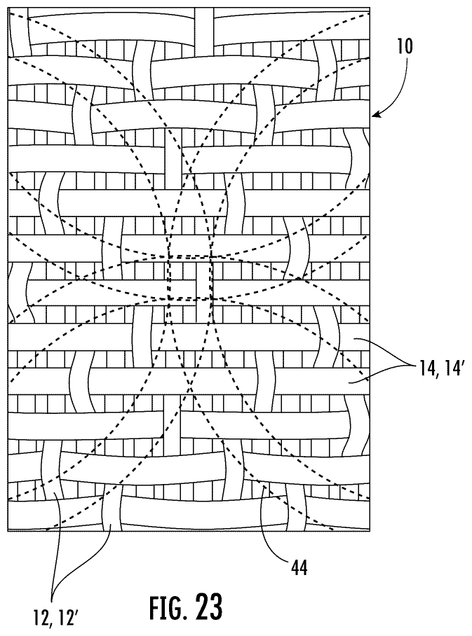

As shown in FIGS. 21 and 22, protrusions 140 extend from the first surface 124 at selected locations 142, with the protrusions 140 comprising an expanded part 133 of the first outer material 122 with a foamed or cellular structure 136 created by the blowing agent 134 being activated in a region adjacent to the first inner material 121 that can optionally be fully encapsulated by a solid portion of the first outer material 122 that does not include the foamed or cellular structure and the first inner material 121, similar to the structure of the protrusion 40 shown in FIG. 4.

Accordingly, in a more general sense, the invention provides an industrial fabric 10, 110 that includes a base material 20, 120 that is formed continuously or has ends that are joined in order to form a belt 23 having a first surface 24, 124 and a second surface 26, 126. At least a portion of the base material 20, 120 at the first surface 24, 124 includes a first inner material 21, 121 formed of a first polymer mixed with carbon black and a first outer material 22, 122 formed of a second polymer and a first blowing agent 34, 134 is located on the first inner material 21, 121. Protrusions 40, 140 extend from the first surface 24, 124 at selected locations 42, 142, with the protrusions 40, 140 comprising an expanded part of the first outer material 22, 122 with a foamed or cellular structure created by the first blowing agent 34, 134 being activated in a region adjacent to the first inner material 21, 121 that is preferably fully encapsulated by a solid portion of the first outer material 22, 122 that does not include the foamed or cellular structure and the first inner material 21, 121. The blowing agent 34, 134 can be a chemical or physical blowing agent, and may be heat activated. The first surface 24, 124 can be a machine side surface where the protrusions 40, 140 provide enhanced wear properties, or a support side surface where the protrusions 40, 140 can be used for various functions, and are of particular interest in industrial fabrics 10, 110 that are papermaking fabrics and the protrusions 40, 140 are used to form a pattern in the paper product being carried or formed.

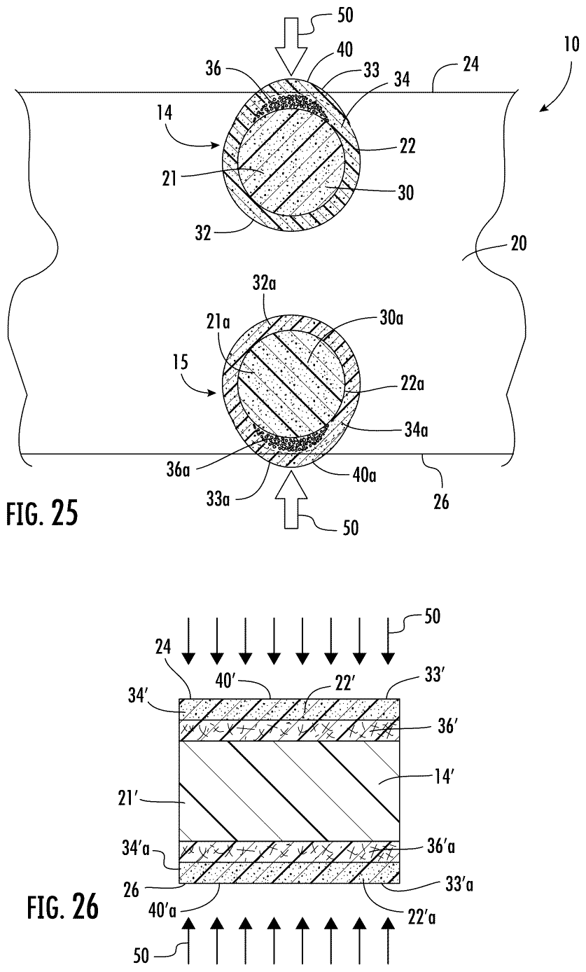

Referring now to FIG. 25, protrusions 40, 40a can be provided on both the first and second surfaces 24, 26. Here, the base fabric 20 has the CD yarn 14, 14′ at the first surface 24, and is shown with a different CD yarn 15 that is formed in a same manner of the CD yarn 14, 14′ in accordance with one or more of the embodiments noted above at the second surface 26. Here, the CD yarn 15 includes a second inner material 21a (similar to the first inner material 21) formed of a third polymer (which can be the same as or different from the first polymer) mixed with carbon black as the core 30a and a second outer material 22a (similar to the first outer material 22) formed of a fourth polymer (which can be the same as or different from the second polymer) and a second blowing agent 34a (which can be the same or different than the first blowing agent 34, 134) as a sheath 32a located on the second inner material 21a. Second protrusions 40a (similar to 40) extend from the second surface 26 at selected second surface locations. The second protrusions 40a comprise an expanded part of the second outer material 22a with a foamed or cellular structure created by the second blowing agent 34a being activated in a region adjacent to the second inner material 21a that is preferably fully encapsulated by a solid portion of the second outer material 22a that does not include the foamed or cellular structure 36a and the second inner material 22a. This provides protrusions 40, 40a on both the first and second surfaces 24, 26 of the base material 20. These protrusions 40 form a topographical pattern of protrusions on the first and/or second surfaces 24, 26 in a simple and easily programmable manner to provide different topographic patterns.

Those skilled in the art will recognize the same CD yarns 14, 14′ (or the MD yarns 12, 12′) could also have protrusions formed on both the first and second surfaces 24, 26 as well. For example, referring to FIG. 26, a further embodiment of a rectangular monofilament 14′ is shown in which both the first and second surfaces 24, 26 have respective protrusions 40′, 40′a. The first surface of the monofilament 14′ is the same as described above in connection with the third embodiment in FIGS. 7 and 8. In addition, a second outer material 22′a (similar to the first outer material 22′) formed of a fourth polymer (which can be the same as or different from the second polymer) and a second blowing agent 34′a (which can be the same or different than the first blowing agent 34′) is located on the second surface 26 of the inner material 21′. Second protrusions 40′a (similar to 40′) extend from the second surface 26 at selected second surface locations. The second protrusions 40′a comprise an expanded part of the second outer material 22′a with a foamed or cellular structure created by the second blowing agent 34′a being activated in a region adjacent to the inner material 21′ that is preferably fully encapsulated by a solid portion of the second outer material 22′a that does not include the foamed or cellular structure 36′a and the inner material 21′. Activation is illustrated as being by laser radiation 50.

In general, when protrusions 40, 140 are desired on both the first and second surfaces 24, 124; 26, 126, it is possible to provide an embodiment where at least a portion of the base fabric 20, 120 at the second surface 26, 126 includes a second inner material (similar to the first inner material 21, 121) formed of a third polymer (which can be the same as or different from the first polymer) mixed with carbon black or another laser absorbing material, if needed to the extent that the first inner material is not intrinsically laser radiation absorbing, a second outer material (similar to the first outer material 22, 122) formed of a fourth polymer (which can be the same as or different from the second polymer), and a second blowing agent (which can be the same or different than the first blowing agent 34, 134) mixed with at least one of the second inner material or the second outer material, and second protrusions 40a, 40′a (similar to 40, 140) extend from the second surface 26, 126 at selected second surface locations. The second protrusions comprise an expanded part of the second outer material with a foamed or cellular structure created by the second blowing agent 34a, 34′a being activated in a region adjacent to the second inner material 22a, 22′a that is preferably fully encapsulated by a solid portion of the second outer material that does not include the foamed or cellular structure and the second inner material. This provides protrusions 40, 140 on both the first and second surfaces 24, 26; 124, 126 of the base material 20, 120. It is also possible to adapt the fourth and/or fifth embodiments of the monofilament as described above to the second surface and provide protrusions formed only of the second inner material that is mixed with the second blowing agent, without having a second outer material.

In each case, these protrusions 40, 40a, 40′a, 140 form a topographical pattern of protrusions on the first and/or second surfaces 24, 26; 124, 126 in a simple and easily programmable manner to provide different topographic patterns.

In another aspect, a method of forming industrial fabric 10, 110 having a first surface 24, 124 with a positive topographic form formed by the protrusions 40, 140 is provided.

The method includes providing a base fabric or material 20, 120 formed continuously or having ends that are joined or are joinable in order to form a belt 23 having a first surface 24, 124 and a second surface 26, 126, at least a portion of the base material 20, 120 at the first surface 24, 124 including a first inner material 21, 121 formed of a first polymer mixed with carbon black or another laser radiation absorbing material, a first outer material 22, 122 formed of a second polymer, and a first blowing agent 34, 134 located in at least one of the first inner material 21, 121 or the first outer material 22, 122. For the embodiment where the base material is the base fabric 20, the first inner material 21 is formed as the core 30 and the first outer material 22 is formed as the sheath 32 for the CD and or MD yarns 14, 12 used to form the base fabric 20.

The method further includes applying energy at selected locations 42, 142 at the first surface 24, 124 of the base material 20, 120, preferably via applying laser energy, in order to activate the chemical blowing agent 34, 134 in a region adjacent to the first inner material 21, 121 to form protrusions 40, 140 that extend from the first surface 24, 124 (for example a height H above the nominal surface as shown in FIG. 4). The protrusions 40, 140 comprise an expanded outer part or sheath material 33, 133 with a foamed or cellular structure 36, 136 created by the chemical blowing agent 34, 134 in the at least one of the first inner material 21, 121 or the first outer material 22, 122 at a region in or adjacent to the first inner material. The foamed or cellular structure 36, 136 is preferably fully encapsulated by a solid portion of the first outer material 122 that does not include the foamed or cellular structure 36, 136.

It is also possible to use the method in connection with the fourth and/or fifth embodiments of the monofilament as described above for forming protrusions only of the first inner material that is mixed with the first blowing agent, without having a first outer material. The method would be modified accordingly to remove the first outer material.

In a preferred embodiment, the applying energy includes applying a laser 50 at the selected locations and generating heat by the laser energy being absorbed by the first inner material 21, 121 based on the inclusion of the carbon black or other laser absorbing material in order to generate heat. The heat is generated at the surface of the first inner material 21, 121 where the laser 50 is applied and preferably reaches an activation temperature in a range of 160-350 °C in the region of the first outer material 22, 122 adjacent to the first inner material 21, 121.

One exemplary heat profile is shown in FIG. 3. Here, the heat profile is designed such that in connection with the first embodiment of the first outer material 22 in the form of the sheath 32, the foamed or cellular structure 36 does not extend to the surface 38 of the first outer material 22, as shown in FIG. 4, which is formed as a solid sheath material surface 38. The same or similar heat profile can be applied to the other embodiments, including the film base material 120.

In a preferred arrangement, the laser 50 is positioned and activated using a controller or processor based on a programmed pattern that can be saved in a fixed memory, and the laser 50 is activated at the selected locations 42 such that in order to form at least one of profiles, patterns, or connected contours of the protrusions 40. This can be accomplished, for example, by providing the laser 50 mounted for movement in a controllable manner in the CD while the fabric 20 is indexed in a stepwise manner in the MD in order to define a relative movement grid between the laser than the base fabric allowing the topographical profiles, patterns, or connected contours of the protrusions 40 to be formed as desired.

The laser energy can be applied by one or more lasers 50 moving along one or multiple paths, with either intermittent or constant energy being applied. Alternatively, industrial systems using high-power near-infrared (NIR) lasers 50 with digital light processing (DLP) technology can be used in which a 2D area is exposed to laser radiation in one shot. This enables complex image printing more quickly than point-by-point laser-movement control systems. DLP technology also enables grayscale imaging for multi-bit depth/height differentiation by programming the micromirrors on- and off-time. This can be used to set and/or control the height of the protrusions 40, 40′, 40a, 40′a, 140 in order to provide different profiles on the base material 20, 120.

For the embodiment of the yarn 12, 14 shown in FIG. 2, in which there is an outer portion 32b of the sheath 32 that is formed of a second polymer without any chemical blowing agent, the heat profile is less critical and it is ensured that the foamed or cellular structure 36 cannot reach the surface 38 of the sheath 32 to the extent that fully encapsulated protrusions 40 are desired.

Preferably, the method is used for making a papermaking fabric 10, 110, and more particularly a TAD fabric.

Having thus described the present invention in detail, it is to be appreciated and will be apparent to those skilled in the art that many physical changes, only a few of which are exemplified in the detailed description of the invention, could be made without altering the inventive concepts and principles embodied therein. It is also to be appreciated that numerous embodiments incorporating only part of the preferred embodiment are possible which do not alter, with respect to those parts, the inventive concepts and principles embodied therein. The present embodiment and optional configurations are therefore to be considered in all respects as exemplary and/or illustrative and not restrictive, the scope of the invention being indicated by the appended claims rather than by the foregoing description, and all alternate embodiments and changes to this embodiment which come within the meaning and range of equivalency of said claims are therefore to be embraced therein.

1. An industrial fabric, comprising:
a base material comprising a belt that is formed continuously or has ends that are joined in order to form the belt having a first surface and a second surface;
at least a portion of the base material at the first surface including a first inner material formed of a first polymer mixed with a laser absorbing material and a first outer material formed of a second polymer, and a first blowing agent located in at least one of the first inner material or the first outer material; and
protrusions extend from the first surface at selected locations, the protrusions comprising an expanded part of the first outer material with a foamed or cellular structure created by the first blowing agent being activated in at least one of the first inner material or the first outer material at a region in or adjacent to the first inner material.

2. The industrial fabric of claim 1, wherein the protrusions are encapsulated between a solid portion of the first outer material that does not include the foamed or cellular structure and the first inner material.

3. The industrial fabric of claim 1, wherein the laser absorbing material is carbon black.

4. The industrial fabric of claim 1, further comprising at least a portion of the base material at the second surface including a second inner material formed of a third polymer mixed with a laser absorbing material and a second outer material formed of a fourth polymer, and a second blowing agent located in at least one of the second inner material or the second outer material; and second protrusions extending from the second surface at selected second surface locations, the second protrusions comprising an expanded part of the second outer material with a foamed or cellular structure created by the second blowing agent being activated in at least one of the second inner material or the second outer material at a region in or adjacent to the second inner material.

5. The industrial fabric of claim 4, wherein the first and the third polymers are a same polymer, and the second and the fourth polymers are of a same polymer, and the first and the second blowing agents are a same blowing agent.

6. The industrial fabric of claim 1, wherein the first blowing agent is a chemical blowing agent.

7. The industrial fabric of claim 6, wherein the chemical blowing agent is heat activated.

8. The industrial fabric of claim 7, wherein the chemical blowing agent is heat activated at an activation temperature in a range from 160-350 °C.

9. The industrial fabric of claim 1, wherein the base material is a fabric including a system of MD yarns connected to a system of CD yarns, and at least one of the CD yarns or the MD yarns include a core formed of the first polymer mixed with the laser absorbing material to form the first inner material, and a sheath or layer formed of the second polymer and the first blowing agent to form the first outer material.

10. The industrial fabric of claim 1, wherein the base material is a fabric including a system of MD yarns connected to a system of CD yarns, and at least one of the CD yarns or the MD yarns include a core formed of the first inner material, and the first outer material is a sheath or layer formed on the core.

11. The industrial fabric of claim 10, wherein the sheath or layer comprises an inner portion formed of the second polymer and the first blowing agent and an outer portion formed of a polymer without any blowing agent.

12. The industrial fabric of claim 10, wherein the second polymer thermoplastic elastomer (TPE) synthesized from homopolymer, copolymer or blends thereof.

13. The industrial fabric of claim 1, wherein the base material is a film having the first inner material formed of the first polymer mixed with the laser absorbing material as a first layer and the first outer material formed of the second polymer formed as a second layer that is located on the first layer.

14. The industrial fabric of claim 1, wherein the industrial fabric is a papermaking fabric.

15. The industrial fabric of claim 1, wherein the protrusions are arranged in a repeating pattern on the first surface which forms a support surface.

16. The industrial fabric of claim 1, wherein the protrusions are arranged in a repeating pattern on the first surface which forms a machine side surface.

17. The industrial fabric of claim 1, wherein the first polymer is homopolymer, copolymer, or blends thereof.

18. The industrial fabric of claim 1, wherein the first blowing agent is a physical blowing agent.

19. An industrial fabric, comprising:
a base material comprising a belt that is formed continuously or has ends that are joined in order to form the belt having a first surface and a second surface;
at least a portion of the base material at the first surface including a first material formed of a first polymer and a first blowing agent; and
protrusions extend from the first surface at selected locations, the protrusions comprising an expanded part of the first material with a foamed or cellular structure created by the first blowing agent being activated in the first material.

20. The industrial fabric of claim 19, wherein the protrusions are fully encapsulated between a solid portion of the first material that does not include the foamed or cellular structure.

21. The industrial fabric of claim 19, wherein the first surface includes a first monofilament formed of the first polymer mixed with the first blowing agent, and the protrusions comprising an expanded portion of the monofilament with the foamed or cellular structure created by the first blowing agent being activated within the monofilament.

22. The industrial fabric of claim 19, wherein the first material further includes carbon black or another laser energy absorbing material.

23. The industrial fabric of claim 19, further comprising at least a portion of the base material at the second surface including a second material formed of a third polymer mixed with a second blowing agent; and second protrusions extending from the second surface at selected second surface locations, the second protrusions comprising an expanded part of the second material with a foamed or cellular structure created by the second blowing agent being activated in the second material.

24. The industrial fabric of claim 23, wherein the first and the third polymers are a same polymer, and the first and the second blowing agents are a same blowing agent.

25. The industrial fabric of claim 19, further comprising a second material formed of a second polymer located on the first material.

26. The industrial fabric of claim 19, wherein the first blowing agent is a chemical blowing agent.

27. The industrial fabric of claim 19, wherein the first blowing agent is a physical blowing agent.

28. A method of forming an industrial fabric having a surface with a positive topographic form, the method comprising:
providing a base material comprising a belt that is formed continuously or has ends that are joined in order to form the belt having a first surface and a second surface, at least a portion of the base material at the first surface including a first inner material formed of a first polymer mixed with a laser absorbing material and a first outer material formed of a second polymer, and a first blowing agent located in at least one of the first inner material or the first outer material; and
applying energy at selected locations at the first surface of the base material to activate the first blowing agent to form protrusions that extend from the first surface, the protrusions comprising an expanded part of the first outer material with a foamed or cellular structure created by the first blowing agent being activated in at least one of the first inner material or the first outer material at a region in or adjacent to the first inner material.

29. The method of claim 28, further comprising encapsulating the protrusions between a solid portion of the first outer material that does not include the foamed or cellular structure and the first inner material.

30. The method of claim 28, wherein the applying energy includes applying a laser at the selected locations and generating heat by the laser energy being absorbed by the first inner material.

31. The method of claim 30, wherein the laser is activated based on a programmed pattern to apply the energy at the selected locations in order to form at least one of profiles or connected contours of the protrusions.

32. The method of claim 30, wherein the laser comprises a high-power near-infrared (NIR) lasers with digital light processing (DLP) technology, and the method further comprises exposing a 2-dimensional area of the first surface with laser radiation in a single laser application, and controlling a height of the protrusions via grayscale imaging control of laser energy application to the first surface.

33. The method of claim 28, wherein the blowing agent is a heat activated chemical blowing agent that is activated at an activation temperature in a range from 160-350 °C, and the heat is generated in this range in a region of the first inner material and/or the first outer material at the interface between the first inner material and the first outer material.

34. The method of claim 28, wherein the method is for making a papermaking fabric.

35. The method of claim 28, wherein the base material is a fabric including a system of MD yarns connected to a system of CD yarns, and at least one of the CD yarns or the MD yarns include a core formed of the first polymer mixed with the laser absorbing material to form the inner material, and a sheath or layer formed of the second polymer and the first blowing agent to form the outer material.

36. The method of claim 28, wherein the base material is a film having the first inner material formed of the first polymer mixed with the laser absorbing material as a first layer and the first outer material formed of the second polymer formed as a second layer that is located on the first layer.

37. A method of forming an industrial fabric having a surface with a positive topographic form, the method comprising:
providing a base material comprising a belt that is formed continuously or has ends that are joined in order to form the belt having a first surface and a second surface, with at least a portion of the base material at the first surface including a first material formed of a first polymer and a first blowing agent; and
applying energy at selected locations at the first surface of the base material to activate the first blowing agent to form protrusions that extend from the first surface at the selected locations, the protrusions comprising an expanded part of the first material with a foamed or cellular structure created by the first blowing agent being activated in the first material.

38. The method of claim 37, wherein the first material further includes carbon black or another laser energy absorbing material.
